(19) United States
(12) Patent Application Publication
(10) Pub. No.: US 2007/0113739 A1
(43) Pub. Date: May 24, 2007

(54) Filter assembly for treating a compressed gas

(75) Inventor: David Porter, Newcastle-upom-Tyne (GB)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Domnick Hunter Limited, Birtley, Co Durham (GB)

(21) Appl. No.: 10/556,099

(22) PCT Filed: May 13, 2003
(86) PCT No.: PCT/GB03/02032

§ 371 Date: Jan. 24, 2006

(51) Int. Cl. B01D 53/02

(52) U.S. Cl. 96/134

(57) ABSTRACT

A filter assembly for treating a compressed gas stream comprises a container which comprises a body and a cap which are sealingly joined to one another at an interface. The body and cap each have a port through which compressed gas can flow. The body contains a quantity of adsorbent material so that gas flowing through the container from one of the ports to the other port flows through the adsorbent material, and a plate located between the adsorbent material and the interface to hold the adsorbent material in place within the body. The cap includes a particle removal filter through which compressed gas passing through the port in the cap will pass, and a skirt which extends into the body to maintain a separation between the plate and the particle removal filter.

This invention relates to a filter assembly for treating a compressed gas stream.

The purity of a gas stream can be important for certain applications. For example, it can be important when a pressurised gas is used in applications in the food and beverage industry. High purity compressed gas can be supplied in appropriate pressurised containers. Gas supplied in gas cylinders can contain impurities in the form of liquid droplets or small particles. For example, compressed carbon dioxide supplied in cylinders can contain trace impurities from the process by which it is process by which it is produced, possibly including benzene, hydrogen sulphide, and acetaldehyde. Gas which is pressurised using a compressor can contain contaminants in the form of fine droplets or compressor oil. It can be desirable for end users to include purification apparatus to ensure adequate purity of pressurised gas that is used in end use applications. Achieving satisfactory purification can require the use of particulate filters and adsorbent materials for impurities.

It can be important when assembling a filter that adsorbent material which is sensitive to contamination is not contaminated, and that the integrity of any particulate filter is not broken.

The present invention provides a filter assembly in which a container for adsorbent material comprises a cap and a body, in which the cap includes a skirt which extends beyond the interface between the cap and the body to maintain separation between the adsorbent material and a particulate filter in the cap.

Accordingly, in one aspect, the invention provides a filter assembly for treating a compressed gas stream, comprising a container which comprises a body and a cap which are sealingly joined to one another at an interface, the body and cap each having a port through which compressed gas can flow, in which (a) the body contains a quantity of adsorbent material so that gas flowing through the container from one of the ports to the other port flows through the adsorbent material, and a plate located between the adsorbent material and the interface to hold the adsorbent material in place within the body, and (b) the cap includes a particle removal filter through which compressed gas passing through the port in the cap will pass, and a skirt which extends into the body to maintain a separation between the plate and the particle removal filter.

The filter assembly of the present invention has the advantage that the design of the cap and body are such that the risk of damaging the adsorbent material or particulate filter during construction of the filter assembly is greatly reduced. The provision of a skirt within the cap which extends into the body, especially extending beyond the interface between the cap and the body, ensures that the particle removal filter and the adsorbent material are a controlled safe distance from the interface so that any undesirable by-product or side effect produced by the sealing of the cap to the body does not result in the contamination of the adsorbent material or a reduction in the integrity of the particle removal filter. Further, the provision of a skirt on the cap which maintains a separation between the plate and the particle removal filter has the advantage that the flow of gas is distributed evenly through the particle removal filter.

Preferably, the filter assembly has a substantially constant cross-sectional shape along its length. Preferably, the cross-section of the filter assembly is generally round. For example, the cross-section may be circular or elliptical. However, it will be appreciated that the cross-section of the filter assembly need not be round. For example, the cross-section could be the shape of a parallelogram, square, rectangle, rhombus, hexagon, pentagon, decagon, triangle or any other regular or irregular shape.

The size of cross-section taken along the length of a filter assembly need not be constant. For example if the cross-section is round, the filter assembly could be conical. Alternatively the filter assembly could be spherical. Alternatively if the cross-section is square or triangular, the filter assembly could be pyramidal.

The cross-sections of the cap and the body at the interface between them should broadly correspond so that the fit together at their sealing surfaces. The skirt on the cap can extend into the body. Preferably, the cross-sections of the cap and body are generally circular, especially generally round. The cross-sections of the cap and the body at the interface need not be necessarily be round. For example, the cross-sections can have the shape of a parallelogram, square, rectangle, rhombus, hexagon, pentagon, decagon, triangle or any other regular or irregular shape.

Preferably, the cap and the body are sealed at the interface without the use of a material other than the materials of the cap and the body. Preferably, the cap and body are sealed at the interface by fusing one or both of the materials of the cap and body together at the interface. Preferably, the materials of both the cap and the body are fused to form the seal at the interface. One or both of the materials can be fused by the direct application of heat, or indirectly, for example by ultrasonic welding, or friction welding. One or both of the materials can be fused by use of a solvent which can soften the material.

Preferably, friction (spin) welding is used to fuse the cap and the body. Preferably, the surface of the cap at the interface is spun against the surface of the body at the interface, so that heat is generated by the friction between the surfaces, causing the material on one or each of the surfaces to soften and to form a weld.

Preferably, the cap can be held by a tool during the assembly process. Preferably, the cap can be gripped by a tool which allows the tool to rotate the cap. Preferably, the cap has a projection on the outside of the cap which is not rotationally symmetrical, allowing the tool to grip the cap and to rotate it around its axis. Preferably, the projection has a polygonal cross-section. Preferably, the cross-section of the projection is generally hexagonal.

It will be appreciated that the cap and body need not necessarily be sealed without the use of a material other than the material of the cap and the body. The cap and body may be sealed at the interface by other techniques such as bonding. For example, the cap and body may be bonded through the introduction of another material such as an adhesive. Alternatively, the cap and body may be coupled through the use of mechanical fixings. Threaded members, studs, rivets, clips are examples of mechanical fixings which could couple the cap and body. Further, the cap and body could be coupled through the use of cooperating threads. The use of an sealing member may be needed in order to provide an air tight seal at the interface when the cap and body are coupled using mechanical fixings. Preferably, the interface is located a distance away from the particle removal filter and the plate. Preferably the distance is such that the process of sealing the cap and the body does not have an adverse effect on the particle removal filter, or the plate or the adsorbent that is located by means of the plate. Preferably, the interface between the cap and the body is located between the particle removal filter of the cap and the plate. However, it will be appreciated that the interface need not necessarily be located between the particle removal filter. For example, the interface may be located between the port of the cap and the particle removal filter.

Examples of materials which can be used for the particle removal filter include sintered porous polymeric materials, for example based on polyolefins such as polypropylene, and polytetrafluoroethylene, microporous polymeric membranes such as polyethersulphones and polytetrafluoroethylene. A preferred material for the particle removal filter is based on microfibres which can be formed from inorganic materials such as glasses, and polymeric materials, for example polyolefins such as polypropylene. The use of polymeric materials has the advantage that the fibres can be readily interconnected by welding, for example by ultrasonic welding. Suitable particle removal filter materials will be apparent.

The plate will generally be perforated. The material of the plate should be capable of withstanding forces that are exerted on it when the filter is in use. The materials should also be inert when exposed to materials to which it is exposed when the assembly is in use. A perforated stainless steel plate can be suitable for use as a support in many applications. Preferably, the plate should not damage the skirt of the cap during the assembly of the filter assembly. More preferably, during friction welding, the skirt should not be damaged by the rotation of the skirt against the perforated plate. Preferably, the friction between the skirt and the plate is minimal. Preferably, the surface of the plate on which the perforations are provided is sufficiently smooth that the skirt is not abraded unacceptably as a result of contact with the plate. The perforations on the plate can be positioned such that the skirt does not contact the plate where the perforations are provided when the cap and body are joined together.

Preferably, the cross-section of the skirt on the skirt corresponds to the cross-section of the body so that the skirt fits closely within the internal wall of the body. Preferably, the skirt extends continuously around the cap. However, it will be appreciated that the skirt need not be continuous and may have one or more breaks around the perimeter of the cap. Further, the skirt need not necessarily conform to the shape of the inner surface of the side of the body. The skirt should generally be capable of supporting the plate within the body. Preferably, the skirt should be capable of maintaining a distance between the plate and the particle removal filter. Preferably, the skirt should not adversely affect the flow of gas through the filter assembly.

Preferably, the particle removal filter is sealed in place within the cap without the use of a material other than the materials of the particle removal filter and the cap. Preferably, the cap is provided with a ridge. Preferably the particle removable filter should fit on to the ridge when the particle removal filter is placed within the cap. Preferably the particle removal filter can be sealed to the cap along the interface between the ridge and the particle removal filter. Preferably, the shape of the particle removal filter and the skirt are such that the particle removal filter is located centrally in the cap by means of the skirt.

The particle removal filter can be sealed to the cap by techniques such as welding or other softening of the material of one or both of the parts of the assembly. Preferably, the particle removal filter is ultrasonically welded to the cap.

The adsorbent material will be selected in order to ensure adequate adsorption of contaminant material in the gas stream, while allowing the selected process gas to pass freely through the filter assembly. Examples of suitable adsorbent materials include activated carbon adsorbents, activated alumina adsorbents, molecular sieve materials and so on. The adsorbent material can contain mixtures of materials, for example which are selected for their different adsorption characteristics towards a range of contaminants in the gas stream.

The filter assembly may be constructed so that the gas line connector can be connected to either of the ports without reducing the quality of the filtered gas stream leaving the filter assembly. In such a filter assembly, a second particle removal filter and a second plate are located between the port of the body and the adsorbent material. The second plate holding the adsorbent material in place, and the second particle removal filter located between the second plate and the port of the body. Preferably, the particle removal filters are substantially identical in relevant respects, for example in terms of one or more of filtration efficiency, dimensions, materials, etc. Preferably, the plates are substantially identical in relevant respects, for example in terms of inertness of the of material of the plate, dimensions, flow resistivity, etc.

An advantage of the provision of particle removal filters between the adsorbent material and both ports of the housing is that particles entrained in the gas stream when it enters the housing can be removed from the gas stream before the adsorbent material is exposed to the gas stream. This can improve the filtration efficiency of the assembly of the invention. It can also lead to a prolonged lifetime for the assembly. Further, the provision of two plates reduces the risk of adsorbent material being lost from the filter assembly due to incorrect orientation of the filter assembly.

The connectors on the ports of the body and cap are functionally equivalent in the sense that a gas line connector can be connected to either of the ports. The ports can differ in some respects, provided that this functional equivalents is preserved. For example, they can differ in appearance, for example in terms of colour. The nature of the ports can be varied to suit particular applications. For example, the ports can have substantially identical threaded formations. Alternatively, the ports can have substantially identical bayonet formations.

In another aspect, the invention provides a beverage dispensing system which comprises a source of compressed gas, a filter assembly of the kind discussed above, an inlet line for compressed gas which is connected to one of the ports on the housing of the filter assembly, and an outlet line which is connected to the other of the ports on the housing to supply the compressed gas for dispensing a beverage.

Preferably, the compressed gas which is treated using the assembly of the present invention is carbon dioxide.

An embodiment of the present invention will now be described by way of example with reference to the accompanying drawings, in which:

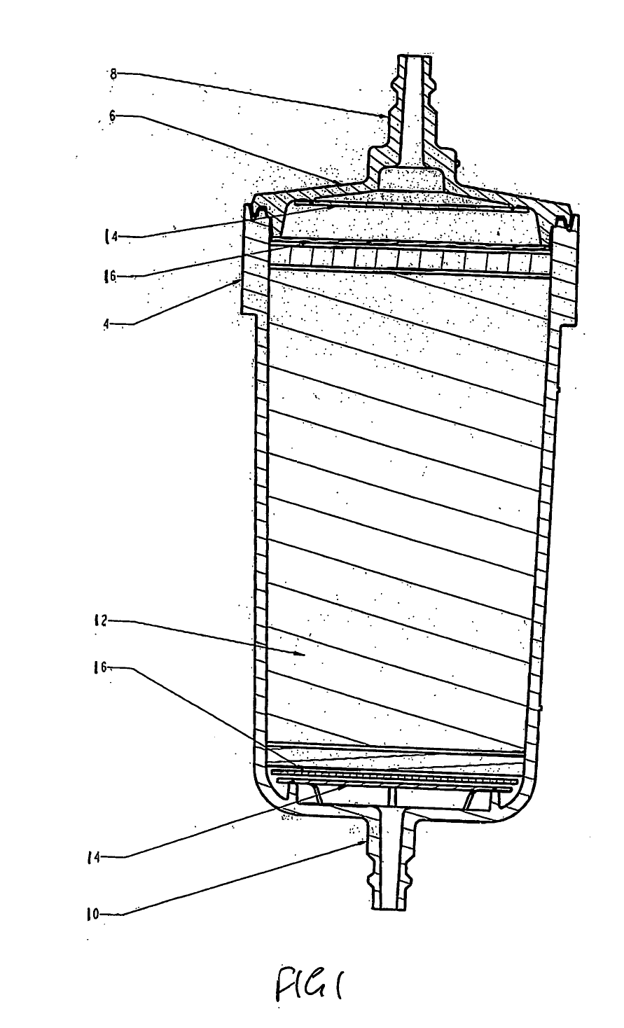

FIG. 1 is a sectional elevation through a filter assembly according to the present invention, and

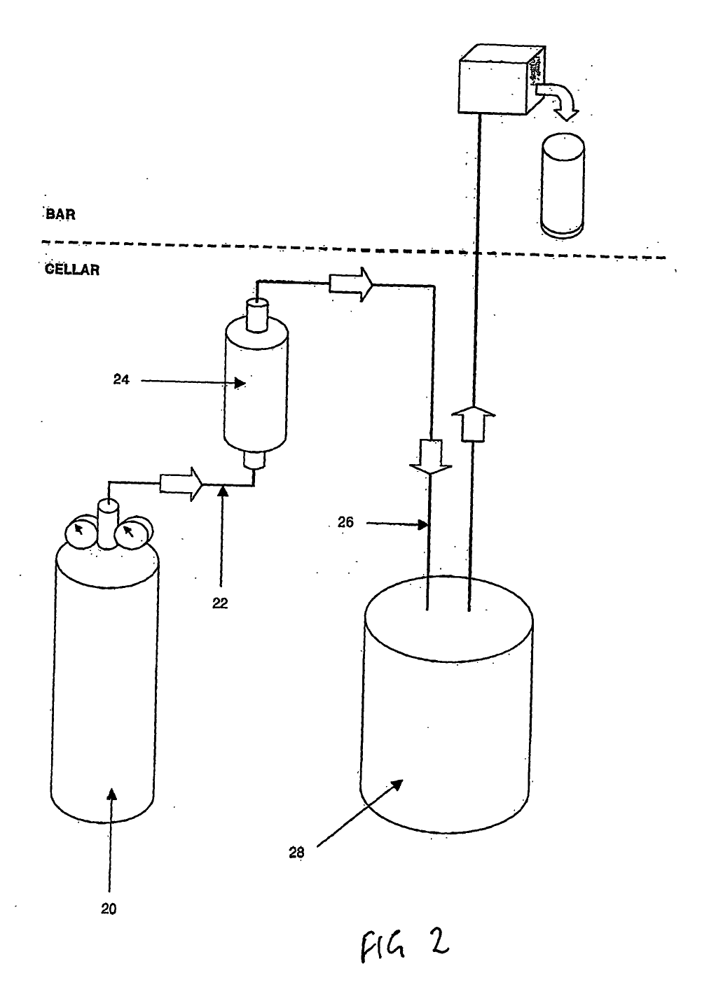

FIG. 2 is a schematic representation of a beverage dispensing system which incorporates the filter assembly shown in FIG. 1.

Referring to the drawings, FIG. 1 shows a filter assembly 2. The assembly housing comprises a body part 4 and a cap 6 which can be fastened and sealed to the body part. For example, the cap and body part can be closed by means of cooperating threads, and sealed by means of a compressible O-ring. They can also be closed by a bonding process for example by welding or by use of another material such as an adhesive, in order to provide an assembly which is resistant to tampering after assembly.

The cap and body part of the housing have identical ports 8, 10 to which mechanical connections can be made to lines for a pressurised gas. For example, each of the ports 8, 10 can have industry standard bayonet formations provided on it.

The body part 4 contains a particulate adsorbent material which can be used for adsorbing contaminants contained in a compressed gas stream. A suitable adsorbent material might be an activated alumina.

Between the particulate adsorbent material 12 and each of the ports 8, 10, there is provided a quantity of glass microfibre filtration media 14, and a perforated stainless steel plate 16. The stainless steel plate is a press fit in the housing, and is held in place within the housing by frictional engagement with the internal wall thereof.

The filter assembly of the invention is assembled by locating a first one of the stainless steel plates 16 in the body part of the housing. The microfibre filtration media 14 is then placed on the stainless steel plate, followed by a mixture of adsorbent materials 12, followed by another layer of the microfibre filtration media 14, and finally the other of the perforated plates 16. The housing is then closed by fastening and sealing the cap 6 to the body part 4.

The assembly of the invention can then be placed in line in a compressed gas system. It can be preferred for the assembly to be arranged for gas to flow in a specified flow direction, either of the ports 8, 10 can be connected to the source of the compressed gas, with the other of the ports connected to the application for the compressed gas. The assembly is therefore able to tolerate installation such that gas flows counter to the specified direction.

FIG. 2 shows a beverage dispensing system. It includes a source 20 for a compressed gas. A compressed gas will generally be carbon dioxide. The carbon dioxide will generally be supplied from a cylinder for the gas under pressure. Gas is fed from the cylinder 20 through an inlet line 22 to a filter assembly 24, which can be of the type described above with reference to FIG. 1. The gas is then fed from the filter assembly 24 through an outlet line 26 and fed to a container 28 for the beverage which is to be dispensed.

1. A filter assembly for treating a compressed gas stream, comprising a container which comprises a body and a cap which are sealingly joined to one another at an interface, the body and cap each having a port through which compressed gas can flow, in which (a) the body contains a quantity of adsorbent material so that gas flowing through the container from one of the ports to the other port flows through the adsorbent material, and a plate located between the adsorbent material and the interface to hold the adsorbent material in place within the body, and (b) the cap includes a particle removal filter through which compressed gas passing through the port in the cap will pass, and a skirt which extends into the body to maintain a separation between the plate and the particle removal filter.

2. A filter assembly as claimed in claim 1, in which the body and the cap are joined to one another without the use of a material other than the materials of the body and the cap.

3. A filter assembly as claimed in claim 1, in which the cap and the body are fabricated from the same material.

4. A filter assembly as claimed in claim 1, in which the body has a particle removal filter bonded to the body between the port of the body and the adsorbent material through which compressed gas passing through the port in the body will pass through the particle removal filter.

5. A filter assembly as claimed in claim 4, in which the body has a second plate positioned between the particle removal filter in the body and the adsorbent material, the second plate holding the adsorbent material in place within the body.

6. A filter assembly as claimed in claim 5, in which the particle removal filter of the body and the support plate are separated from each other.

7. A filter assembly as claimed in claim 1, in which the ports have substantially identical formations to enable the ports to be connected to compressed gas lines.

8. A filter assembly as claimed in claim 1, in which the particle removal filter comprises a layer of fibrous material.

9. A beverage dispensing system which comprises:
a. a source of compressed gas,
b. a filter assembly as claimed in claim 1,
c. an inlet line for a compressed gas, which is connected to one of the ports on the housing of the filter assembly,
d. an outlet line which is connected to the other of the ports on the housing, to supply the compressed gas for dispensing a beverage.

10. A system as claimed in claim 9, in which the source of the compressed gas is a source of carbon dioxide.
